(19) United States
(12) Patent Application Publication
(10) Pub. No.: US 2022/0290886 A1
(43) Pub. Date: Sep. 15, 2022

(54) Filter Monitoring Device, Air Flow System and Corresponding Methods

(71) Applicant: Westermeyer Industries Inc., Bluffs, IL (US)

(72) Inventors: David Robert Frenk, Chatham, IL (US); Theodoros Panagiotis Koukoravas, Chatham, IL (US)

(21) Appl. No.: 17/693,693

(22) Filed: Mar. 14, 2022

Related U.S. Application Data
(60) Provisional application No. 63/161,082, filed on Mar. 15, 2021.

(51) Int. Cl. F24F 11/39; B01D 46/00; B01D 46/44

(52) U.S. Cl. CPC F24F 11/39; B01D 46/0086; B01D 46/446

(57) ABSTRACT

A filter monitoring device for an air flow system is described herein, which comprises a circuit board comprising a first pressure measurement component and a second pressure measurement component, and including hardware and software configured to communicate pressure measurements to a remote computer. The device also includes a sensor comprising a first pressure sensor component comprising a first tube having a first end portion configured to be connected to the circuit board and a second end portion configured to be connected to a first location in the air flow system upstream from and external to a filter media compartment, and a second pressure sensor component comprising a second tube having a first end portion configured to be connected to the circuit board and a second end portion configured to be connected to a second location in the air flow system downstream from and external to the filter media compartment. Corresponding systems and methods also are disclosed.

### RELATED APPLICATIONS

This application claims the benefit of U.S. Provisional Patent Application No. 63/161,082 filed Mar. 15, 2021.

### BACKGROUND

Residential and commercial HVAC systems typically have a filter installed before the primary air handler blower unit. The filter removes airborne debris of various sizes typically indicated on the micron scale. Various manufacturers of these filters design the structure of the filter media to capture airborne debris and/or pathogens. Depending upon application and installation location, the filter filtration rating can vary. ASHRAE (American Society of Heating Refrigerating and Air-Conditioning) provides a rating metric known as MERV (Minimum Efficiency Reporting Value). The following outlines MERV ranges and removal of particle types by a filter rated by this system.
MERV 1-4: Pollen, dust mites, spray paint, carpet fibers
MERV 5-8: Mold spores, cooking dust, hair spray, furniture polish
MERV 9-12: Lead dust, flour, auto fumes, welding fumes
MERV 13-16: Bacteria, smoke, sneezes
MERV 17-20: Viruses, carbon dust

Typical residential filters range between MERV 9-12. Air flow resistance increases as the MERV rating increases, given smaller passages within the filter membrane to allow less air to pass. During normal operation of the air handler unit the filter will trap or contain particles on the surface. After a longer duration of use, continued accumulation of particle will result, therefore further increasing air flow resistance. An air flow resistance increase will result in potential increased wear on the blower motor and less air movement around the building or residence. Prolonged air flow resistance results in less air flowing across the air conditioning or furnace heat exchanger. Decreased air flow reduces the heat exchanger efficiency, therefore requiring the air conditioning or heating furnace to operate at longer intervals to maintain the desired temperature in the conditioned or heated space, resulting in higher energy cost. A side effect to lower air flow is not allowing for adequate air flow across the blower motor to keep it cool. A higher motor operating temperature may cause premature failures, and for some models activate a thermal shutdown.

### SUMMARY

One embodiment described herein is a filter monitoring device for an air flow system, the filter monitoring device comprising a circuit board including a first pressure measurement component and a second pressure measurement component, and including hardware and software configured to communicate pressure measurements to a remote computer. The device also includes a sensor comprising a first pressure sensor component comprising a first tube having a first end portion configured to be connected to the circuit board and a second end portion configured to be connected to a first location in the air flow system upstream from and external to a filter media compartment, and a second pressure sensor component comprising a second tube having a first end portion configured to be connected to the circuit board and a second end portion configured to be connected to a second location in the air flow system downstream from and external to the filter media compartment.

Another embodiment described herein is an air flow system comprising a duct, a blower configured to move air through the duct, a compartment containing filter media configured to remove particulates from the air moving through the duct, and a filter monitoring device. The filter monitoring device includes a circuit board comprising a first pressure measurement component and a second pressure measurement component, and including hardware and software configured to communicate pressure measurements to a remote computer, and a sensor. The sensor includes a first pressure sensor component comprising a first tube having a first end portion configured to be connected to the circuit board and a second end portion configured to be connected to a first location in the air flow system upstream from and external to the filter media compartment, and a second pressure sensor component comprising a second tube having a first end portion configured to be connected to the circuit board and a second end portion configured to be connected to a second location in the air flow system downstream from and external to the filter media compartment.

Yet another embodiment is a filter monitoring device installed external to a filter media compartment, wherein flexible tubing is routed to a first location upstream from the filter media and a second location downstream from the filter media and to a circuit board internal to the device, wherein the circuit board contains components configured to measure a pressure difference between the first location and the second location. In some cases, the circuit board executes predefined software instructions to determine filter air flow restriction, and wherein the circuit board initiates wireless communications with at least one of a wireless electronic device and an external internet server. In embodiments, the flexible tubing includes first and second tubes terminating upstream and downstream from the filter media, the tubes being positioned in tube connections that penetrate furnace ductwork upstream and downstream from the filter media, and wherein the filter monitoring device derives static pressure variants from first and second tubes.

In some cases, the pressure difference is measured using piezo-resistive sensing elements that transmit digital signals to a software controlled micro-controller mounted to the circuit board. In embodiments, the device is configured to continuously execute software instructions to determine filter media air flow resistance by use of algorithms and variables. In certain embodiments, the variables are established during device setup.

In some embodiments of the filter monitoring device, it is configured to connect wirelessly to a remote computer to initiate device setup, by means of downloaded device application, for software variables of (a) connection credentials to a local area network to allow connection to an external internet server, (b) device calibration upon filter replacement per filter ratings and actual flow resistance inherent with new filter media, and (c) maximum expected blower air movement in feet per minute.

### BRIEF DESCRIPTION OF THE DRAWINGS

FIG. 1 shows a top view of a first embodiment of a filter monitoring device displaying internals, measurement connections, and mounting provisions.

FIG. 2 depicts a system containing the filter monitoring device of FIG. 1, the device as installed including flex tube routing to before and after filter media.

FIG. 3A is a graph showing the relationship between pressure drop and air flow in a first embodiment using a filter with the MERV 13 rating.

FIG. 3B is a graph showing the relationship between pressure drop and air flow in a second embodiment using a filter with the MERV 11 rating.

FIG. 4A is a graph showing the relationship between blower motor current and air flow in the first embodiment using a filter with the MERV 13 rating.

FIG. 4B is a graph showing the relationship between blower motor current and air flow in the second embodiment using a filter with the MERV 11 rating.

### DETAILED DESCRIPTION

The products, systems and methods described herein provide for improved heater and/or air conditioner efficiency and cleaner air in a home or other building. In accordance with the disclosed embodiments, owners of residential and commercial buildings are able to operate their heat and/or air conditioning systems at improved efficiency levels while, at the same time, reducing the frequency at which physical inspections of air filters used in heat and/or air conditioning systems need to be conducted.

Furnace filters will naturally decrease the flow through an air handler ducting system. Filters with higher MERV ratings are not always the best solution. The large range of available filters within home improvement shops often adds confusion for an individual without prior knowledge. Three factors can contribute to the overall performance of a filter, air flow rate, MERV rating, and allowable pressure drop across the filter. Higher air flow rates should be paired with filters that will not create high pressure drops, otherwise adding to the long-term wear of the blower motor.

Recommended filter replacement schedules are usually three months but may vary depending upon installation location, scheduled maintenance plans, indoor air quality, individual health conditions, and the filter MERV rating. Higher MERV rating filters may need to be replaced on shorter intervals. An assumption can be made that most homeowners do not replace the furnace filter on a regular schedule. Given this assumption many filters could be reducing overall furnace and air condition efficiency from reduced air flow, thereby increasing heating and cooling costs. In some instances, the standard three-month replacement interval may be too frequent from lack of debris collecting on the filter surface. The unnecessary replacement of a filter will only increase costs for the owner.

The embodiments explained herein can detect decreased air flow and then warn the homeowner or other building owner that the filter must be replaced utilizing wireless technologies and internet connections.

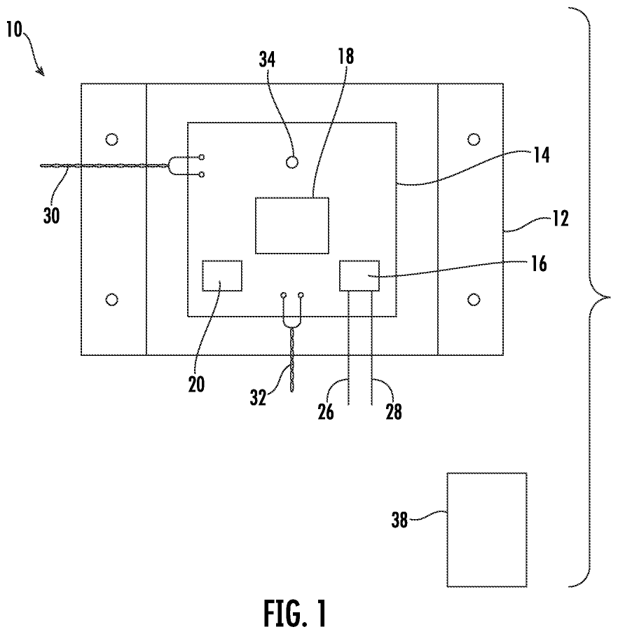

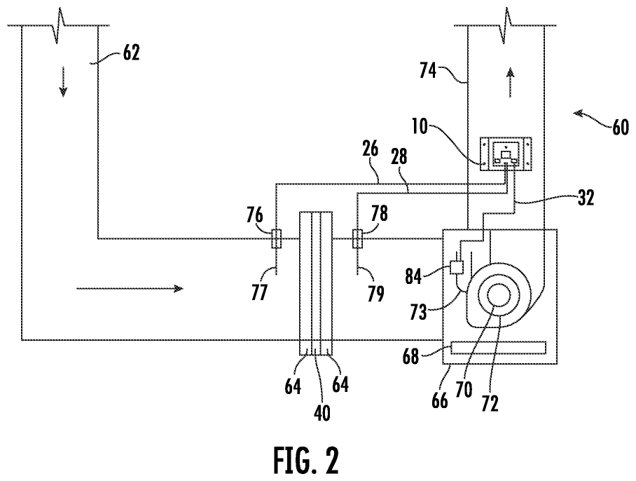

FIG. 1 shows a first embodiment of a filter monitoring device, generally designated as 10. The monitoring device 10 includes a housing 12 containing a circuit board 14. The circuit board includes a differential pressure sensor 16, a microcontroller 18 and a network communication processor 20. The differential pressure sensor 16 includes a first pressure sensor 26 configured to measure pressure upstream from a filter 40 (shown in FIG. 2) and a second pressure sensor 28 configured to measure pressure downstream from the filter 40. The differential pressure sensor 16 provides differential pressure data to the microcontroller 18, which determines when the filter 40 needs replacement based upon its pressure drop data and current input from signal input 32. The monitoring device 10 is powered through an electrical power supply line 30. The monitoring device 10 includes an analog input from a current transformer through signal line 32. A light 34 indicates the “on” status of the monitoring device 10. In embodiments, the light 34 can be one or more lights indicating the status of the filter, i.e., whether or not the filter 40 is in need of replacement.

The network communication processor 20 is configured to wirelessly communicate with a remote computer 38, providing data indicative of differential pressure, and/or data indicative of a need to change a filter. In some cases, a signal is transmitted when the difference between the first and second pressure sensor components is greater than a first set point. In other cases, data is transmitted continuously or at periodic intervals. In embodiments, the remote computer comprises at least one of a smartphone, tablet computer, laptop computer, desktop computer and pager.

The differential pressure sensor 16 can be any suitable sensor capable of detecting changes in pressure. Non-limiting examples of pressure sensors include piezoresistive sensors, piezoelectric sensors, capacitive sensors, and electromagnetic sensors. In some embodiments, the sensors are piezoresistive sensors. Piezoresistive sensors can be exposed to elevated temperatures, pressures and EMI with no long-lasting effect to their operation.

FIG. 2 shows an HVAC (heat, ventilation, air conditioning) system 60 that incorporates the filter monitoring device 10 of FIG. 1. The system 60 includes an air intake duct 62, commonly referred to as a return duct, a filter mount 64 that supports the filter 40, a furnace 66 that includes a heating unit 68, a blower fan wheel 72 with a blower motor 70 with a power supply 73, and an air supply duct 74. The differential pressure device 10 is mounted in close proximity to the filter housing 64. The sensing end 76 of the first pressure sensor 26 is mounted upstream from and proximate the filter 40 and the sensing end 78 of the second pressure sensor 28 is mounted downstream from and proximate the filter 40. In embodiments, the first and second pressure sensors 26 and 28 have probes 77 and 79, respectively, disposed in the air intake duct 62.

In addition to a differential pressure sensor 16, a current clamp 84 can also be installed on the hot leg or neutral of the 120v power supply to the blower motor 70. The current clamp 84 is configured to measure and output the electrical current through a cable without invasion of the electrical conductor insulation. The output of the current clamp 84 is routed to the device circuit board 14 through line 32. The pressure monitoring device 10 utilizes this input for two reasons. First, it provides a signal as to when the furnace 66 is operating. The differential pressure device 10 only needs to be operating when the blower motor is operating, otherwise unnecessary data is reported to the data collection computer, such as an internet cloud service. Second, testing has demonstrated that to maintain adequate air flow across a dirty filter a variable speed motor will need to operate at higher revolutions per minutes (RPMs). An electrical motor operating at higher RPMs requires higher electrical current, however this is dependent upon the torque required to turn the armature shaft of the motor. Variable speed motors are controlled by a central thermostat control, where the control will increase the speed of the motor to satisfy heating/cooling requirements. As the motor RPM increases, torque required to rotate the fan wheel increases, to maintain adequate air flow. Electrical current requirement increases. If this device is installed on a single speed motor the electrical current will overall decrease with a dirty filter, due to decreased air flow. By measuring the electrical current the device can then estimate the reduced air flow, therefore providing another data point for the circuit board micro-controller algorithms. At device setup the user will need to input the furnace blower type via a mobile computer application, single or variable speed. Depending upon this type, pressure differential and electrical current trends can be analyzed concurrently.

In embodiments, the housing or case for the circuit board has an external set of lights that inform an observer of the remaining useful life of the filter. For example, 3-6 lights can be used noting different stages of filter condition. In some cases, in place of lights, a low volume audible alarm (beep or constant sound) could be used, although this method not preferred for hard to reach furnace locations.

The wireless communications between the circuit board and a computer application can be through Bluetooth and/or connection to an external cloud server. The cloud server would require the end user to log onto a portal with login credentials. This is one way in which a specific device's media access control (MAC) address can be tied to a user account.

In some cases, the housing for the filter monitoring device is mounted to a duct with magnets. An alternative to magnets could be self-tapping screws that would penetrate ducting sheet metal. The case or housing for the filter monitoring device can have mounting flanges or other provisions for these screws. Plastic tie wraps or another suitable device can fasten the housing or case to an existing pipe or structure near the filter cabinet. If magnet mounts are used, positioning of the Wi-Fi and Bluetooth IC antennas may need to be considered when in close proximity of a ferrite magnet.

### EXAMPLES

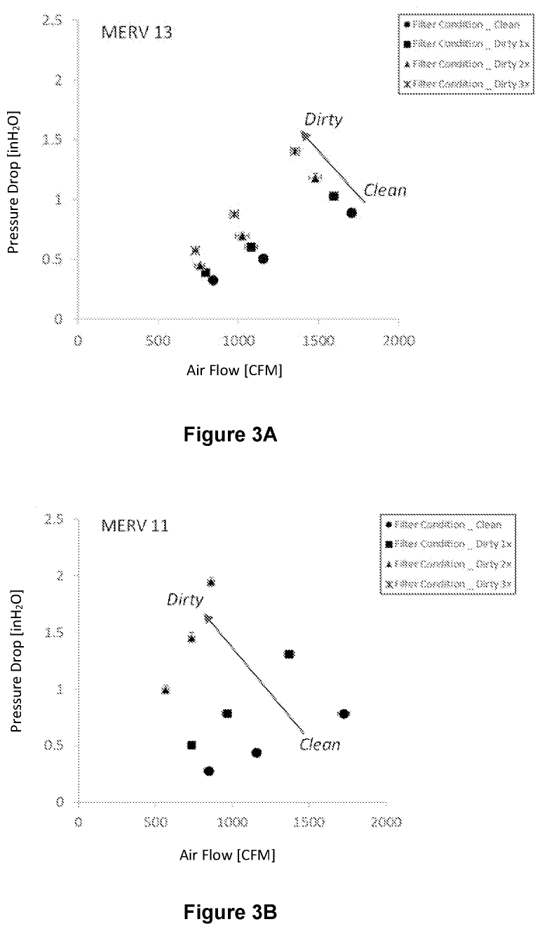

Experiments to characterize the device operation were performed on an in-house air handling setup comprising 18″×22″ rectangular cross-section duct before and after a variable speed air blower motor. Two flexible tubes incorporated in the device for measuring pressure differential were positioned within 2″ away from the air filter, upstream and downstream from the filter respectively, to record the static pressure differential across the filter. The current transducer connected to the device was mounted on the common wire of the single-phase variable speed motor to measure the current consumed by the motor at different testing conditions. A hot wire anemometer, which was not part of the device being tested, was also mounted at the inlet of the ductwork, before the air filter, to measure the velocity and temperature of the air flow at different testing conditions. The temperature measurement ensured that all tests were run at the same environmental conditions. The air flow velocity measurements were converted to volumetric flow rate measurements (CFM=cubic feet per minute) which provides a representation of the size of a particular HVAC installation. This provided a reference point showcasing the size of the experimental setup. When a new filter was installed, the baseline was established by running the setup at different motor speeds for at least three times each so that the necessary data was gathered, and repeatability of the measurements was ensured. A scale was then used to measure the contaminant weight which was kept constant in between contaminant deposition runs. The motor was then run at high speed as the contaminant was slowly released at the air inlet and allowed to collect at the air filter, gradually increasing the pressure drop across the air filter. The setup was then run at three motor speeds multiple times as described earlier to collect data with a contaminated filter. Finally, the air filter contamination process was repeated until at least a 20% reduction in air flow was observed. The results are presented in FIGS. 3A and 3B in the form of [average]±[one standard deviation].

In FIGS. 3A and 3B, curves are categorized according to the condition of the filter. Namely, circles, squares, triangles, and stars represent clean, dirty after one, two and three contaminant depositions respectively. FIGS. 3A and 3B depict pressure drop across the air filter versus air flow expressed in CFM for two different MERV rating filters tested. Pressure drop across an HVAC system air filter is plotted against volumetric flow rate for two different MERV rating filters. The filter condition was altered as explained above and is represented by different shapes on the graphs. The clean filter condition is established when a new filter is installed, and the setup is allowed to run for a complete data collection period that lasts less than 30 min. During this period, the filter condition is considered to remain unaltered by ambient air contaminants since pressure drop remains constant which is evident by the small error bars in all conditions explored. The same assumption about constant filter conditions during data collection is made for all cases described herein. Three points per filter condition are shown in the graphs, which correspond to three different air blower motor speeds. It is evident that as the motor speed increases, the air flow and pressure drop across the air filter also rise as expected, even for constant filter conditions. The clean MERV 13 rated filter shows a pressure drop of approximately 0.3″ H₂O at 800 CFM and rises to 0.9″ H₂O at 1700 CFM, while for MERV 11 the high speed pressure drop is 0.8″ H₂O. This is also evident by the slope of the clean filter curves for the two MERV ratings, as the higher MERV rating curve displays a higher slope as well, meaning that pressure drop rises more as air flow increases.

As the filter condition deteriorates, the slope for both filters increases indicating that for the same air flow the resistance to the flow posed by the filter is now larger, which is materialized by a rise in pressure drop across the filter element. For example, by comparing the cases where the motor speed is kept constant and the filter condition deteriorates, air flow decreases while pressure drop increases, as shown by the red arrows in FIGS. 3A and 3B. This can be detrimental to the efficiency of the HVAC system since that air flow decrease will also decrease the amount of heat exchange across the chiller or furnace. In addition, by looking at the extreme cases (clean vs dirty 2×) of the MERV 11 filter, it is obvious that if the HVAC system was required to maintain the same air flow around 800 CFM on both cases, the blower motor would have to switch from low to high speed in order to overcome the excess pressure drop.

As mentioned above, the contaminant deposition process was maintained identical by weighing the contaminant beforehand to ensure uniform testing conditions. However, it is apparent that the MERV 11 rated filter pressure drop reached 2″ H₂O at high motor speed after only two depositions, while the MERV 13 filter pressure drop remained below 1.5″ H₂O at high motor speed even after three depositions. So, assuming a new filter installed on a residential HVAC system running at regular intervals under uniform air quality conditions, the time it takes for the filter condition to deteriorate largely depends on the filter itself. This illustrates that a user attempting to change out a filter based on a time frame after installation only can significantly affect HVAC system efficiency or generate unnecessary waste by changing out filters too often and increase cost to the user. Instead, the device proposed here can provide a more accurate measurement of filter condition and allow the user to make an educated decision on when to replace it.

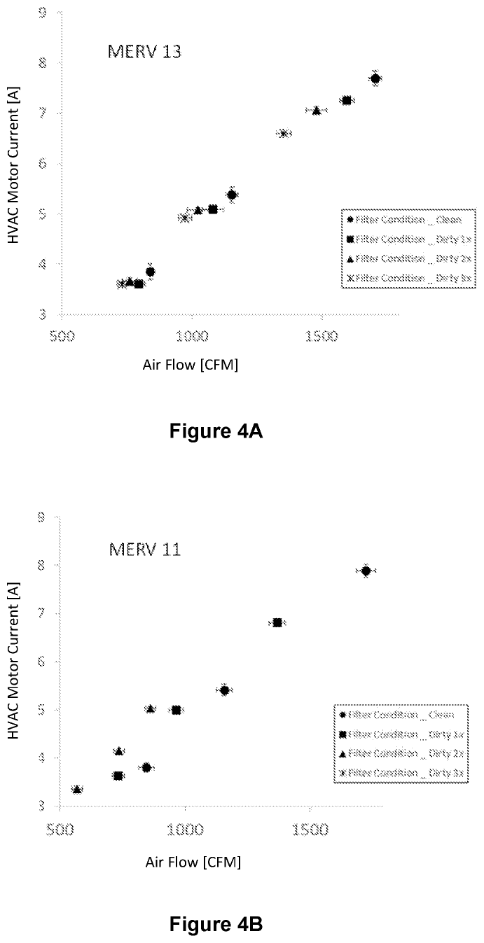

FIGS. 4A and 4B show the blower motor current draw plotted against the volumetric air flow in CFM for three different motor speeds and two different MERV rating filters. The condition of the filters and motor speed were varied, and the results are presented according to the filter condition. Specifically, circles, squares, triangles, and stars correspond to a clean and progressively dirtier air filter respectively. The same symbol notation that was described above for FIG. 1 is maintained here. A common trend observed in all cases is as the motor speed increases, the current consumption increases as well, which is the expected behavior. In the specific setup, motor current draw at low speed for the MERV 13 rated filter revolved around 3.7 A regardless of filter condition, while for MERV 11 it was dependent on filter condition and varied from 3.8 A to 3.3 A. In all other cases current draw was a function of filter condition and motor speed as well, varying from approximately 8 A at high speed with a flow rate of 1700 CFM for a clean MERV 11 filter, down to 5 A at 800 CFM for a highly contaminated MERV 11 filter, which accounts for almost a 40% reduction in current.

When the filter condition starts deteriorating it was shown earlier that pressure drop increases while air flow decreases at constant motor speed, which leads to the motor current draw decreasing as well. This could be explained by the fact that at constant motor speed, reducing the air flow through the motor results in reduced load, which in turn decreases current draw. The reduced electrical current does not translate into notable energy savings for the user, as the blower motor electrical requirements are a fraction of the overall system energy requirements, with a variance between heating and cooling modes. Maintaining air flow at a constant level regardless of filter condition would indicate motor speed and therefore current would need to increase as the filter condition deteriorates. This is illustrated by observing the clean filter condition at low speed for the MERV 11 filter and the dirty filter condition (2×) at high speed, both exhibiting 800 CFM air flow. However, there is a 40% increase in current between these two conditions stemming from the fact that the blower motor needs to consume more energy to overcome the increased air flow resistance from the dirty filter.

Single speed blower motors may be more common among smaller residential properties, given their lower cost. In this case as the filter becomes contaminated and allows less air flow, the motor current will decrease, but the overall decreased cooling or heating efficiency would net a higher operating cost for the owner.

A number of alternatives, modifications, variations, or improvements therein may be subsequently made by those skilled in the art, which are also intended to be encompassed by the following claims.

1. A filter monitoring device for an air flow system, comprising:
a circuit board comprising a first pressure measurement component and a second pressure measurement component, and including hardware and software configured to communicate pressure measurements to a remote computer, and
a sensor comprising:
a first pressure sensor component comprising a first tube having a first end portion configured to be connected to the circuit board and a second end portion configured to be connected to a first location in the air flow system upstream from and external to a filter media compartment, and
a second pressure sensor component comprising a second tube having a first end portion configured to be connected to the circuit board and a second end portion configured to be connected to a second location in the air flow system downstream from and external to the filter media compartment.

2. The filter monitoring device of claim 1, wherein the circuit board software is configured to determine whether the pressure difference detected between the first and second pressure sensor components is greater than a first pressure difference.

3. The filter monitoring device of claim 1, wherein the circuit board software is configured to determine continuous or periodic pressure difference measurements between the first and second locations in the air flow system.

4. The filter monitoring device of claim 2, wherein the filter monitoring device is configured to electronically transmit a signal to the remote computer when the difference between the first and second pressure sensor components is greater than the first pressure difference.

5. The filter monitoring device of claim 3, wherein the filter monitoring device is configured to periodically electronically transmit pressure difference measurements to the remote computer.

6. The filter monitoring device of claim 1, further comprising a housing configured to contain the circuit board, first end portion of the first tube, and first end portion of the second tube.

7. The filter monitoring device of claim 3, wherein the housing is configured to be mounted to a duct located proximate the filter.

8. The filter monitoring device of claim 3, wherein the housing comprises at least one of a thermoplastic material and a thermoset material.

9. The filter monitoring device of claim 1, wherein the remote computer comprises at least one of a smartphone, tablet computer, laptop computer, desktop computer and pager.

10. The filter monitoring device of claim 1, wherein the pressure sensor comprises at least one of a piezoresistive sensor, a piezoelectric sensor, a capacitive sensor, and an electromagnetic sensor.

11. The filter monitoring device of claim 1, wherein the first pressure sensor comprises a piezoresistive sensor. The filter monitoring device of claim 1, where output of a current clamp is connected to the device circuit board, the current clamp being attached to an electrical input of an air handler blower motor

13. An air flow system comprising:
a duct,
a blower configured to move air through the duct,
a compartment containing filter media configured to remove particulates from the air moving through the duct, and
a filter monitoring device that includes:
a circuit board comprising a first pressure measurement component and a second pressure measurement component, and including hardware and software configured to communicate pressure measurements to a remote computer, and
a sensor comprising:
a first pressure sensor component comprising a first tube having a first end portion configured to be connected to the circuit board and a second end portion configured to be connected to a first location in the air flow system upstream from and external to the filter media compartment, and
a second pressure sensor component comprising a second tube having a first end portion configured to be connected to the circuit board and a second end portion configured to be connected to a second location in the air flow system downstream from and external to the filter media compartment.

14. The system of claim 12, wherein the air flow system is a residential system.

15. The system of claim 12, wherein the filer monitoring device is contained in a housing mounted to the duct by magnets.

16. A filter monitoring device installed external to a filter media compartment, wherein flexible tubing is routed to a first location upstream from the filter media and a second location downstream from the filter media and to a circuit board internal to the device, wherein the circuit board contains components configured to measure a pressure difference between the first location and the second location.

17. The filter monitoring device of claim 16, wherein the circuit board executes predefined software instructions to determine filter air flow restriction, and wherein the circuit board initiates wireless communications with at least one of a wireless electronic device and an external internet server.

18. The filter monitoring device of claim 17, wherein the flexible tubing includes first and second tubes terminating upstream and downstream from the filter media, the tubes being positioned in tube connections that penetrate furnace ductwork upstream and downstream from the filter media, and wherein the filter monitoring device derives static pressure variants from first and second tubes.

19. The filter monitoring device of claim 17 wherein the pressure difference is measured using piezo-resistive sensing elements that transmit digital signals to a software controlled micro-controller mounted to the circuit board.

20. The filter monitoring device of claim 17, wherein the device is configured to continuously execute software instructions to determine filter media air flow resistance by use of algorithms and variables.

21. The filter monitoring device of claim 20, wherein the variables are established during device setup.

22. The filter monitoring device of claim 17, wherein the device is configured to connect wirelessly to a remote computer to initiate device setup, by means of downloaded device application, for software variables of
connection credentials to a local area network to allow connection to an external internet server,
device calibration upon filter replacement per filter ratings and actual flow resistance inherent with new filter media, and
maximum expected blower air movement in feet per minute.

23. The filter monitoring device of claim 17, further comprising a series of 3-6 light emitting diodes (LED) illuminating from the surface of a device case, where each LED represents a different level of air flow resistance of the filter media.

24. The filter monitoring device of claim 17, further including magnetic mounts configured to mount the case to metal ductwork.
